(19) United States
(12) Patent Application Publication
(10) Pub. No.: US 2008/0289328 A1
(43) Pub. Date: Nov. 27, 2008

(54) Power Piston Sealing Assembly

(75) Inventors: Per D. Sollie, Sheffield (GB); Lars Kjosbakken, Sheffield (GB); Sven Erik Fossum, Sheffield (GB); Eldar Onsoyen, Sheffield (GB); Sverre Johansen, Sheffield (GB)

Correspondence Address: CHRISTIAN D. ABEL, ONSAGERS AS, POSTBOKS 6963 ST. OLAVS PLASS, NORWAY, N-0130, NO

(73) Assignee: DISSENCO LIMITED, Sheffield (GB)

(21) Appl. No.: 11/912,504

(22) PCT Filed: Apr. 26, 2006
(86) PCT No.: PCT/GB2006/001555

§ 371 Date: May 22, 2008

(30) Foreign Application Priority Data
Apr. 26, 2005 (GB) 0508451.2

(51) Int. Cl. F02G 1/053; F16J 1/00; F16J 9/12

(52) U.S. Cl. 60/520; 92/172; 277/434

(57) ABSTRACT

A power piston sealing assembly in conjunction with a Stirling engine is disclosed. The power piston sealing assembly consists of one or several sealing retainers with threads alternatively using fasteners within the power piston. Said power piston sealing assembly comprises of a power piston, displacer rod seal(s), displacer seal spring(s) and sealing retainer(s) all concentrically mounted within the power piston.

### TECHNICAL FIELD OF THE INVENTION

The invention relates to a power piston sealing assembly for a Stirling engine.

### BACKGROUND OF THE INVENTION

Stirling engines offer advantages of multi-fuel capabilities (geothermal, solar, bio-, fossil- and nuclear fuel), very low NOₓ and HC emissions when burning fossil fuels, very high total efficiency (particularly when used with CHP), and very low maintenance compared to internal combustion engines.

The principle of operation of a Stirling engine can be described with reference to FIG. 1. A displacer (a) and power piston (b) reciprocate within a cylinder with a fixed charge of working gas (e.g. air, nitrogen, helium or hydrogen). The displacer and power piston are connected to a crankshaft (c) via crossheads, connecting rods (d) and wristpins. As the displacer (a) reciprocates, it displaces the working gas (usually nitrogen or helium in production engines) through heater head tubes (e), regenerator (f) and cooler (g) that are placed in the hot and cold portions of the engine. The displacer (a) and power piston (b) have different phase angles so that more work is put into the power piston during the expansion stroke, when most of the gas is in the hot space, than the work the piston returns to the gas a cycle later to compress cold gas back to the hot part of the engine. The net surplus of expansion work over compression work is extracted as useful work by the power piston, which in turn is transferred to the crankshaft (c) with its outgoing shaft. All external heat is supplied at the heater head (e) and rejected in the cooler (g). The regenerator (f) absorbs heat from the working gas as the gas moves from the hot end to the cold end. It returns the stored heat to the working gas when the gas is pushed from the cold end to the hot end. One can say that the regenerator acts as a “thermal dynamic sponge”.

There exist several types of Stirling engines; α-, β- and γ-types. In addition there are engines with oil lubrication and non-lubricated (or lubricated for life) engines. Next, there are engines that are hermetically sealed, and ones that have a so called “atmospheric” crankcase where there is a need for a seal between the oil lubricated crankshaft assembly, displacer rod and power piston rings. This is necessary to avoid oil contamination in the hot circuit of the Stirling process, which would be detrimental to the function of the regenerator, cooler and heater tubes.

In a hermetically sealed, non-lubricated β-type engine there is still a need to seal the crankcase from the Stirling circuit. This is necessary to avoid the phenomina known as “pumping”. This is a state where the pressure differential between the power piston and crankcase is high enough to cause loss of pressure from the Stirling circuit and an increase of pressure in the crankcase. These pressure differentials can be destructive to the performance and efficiency of the Stirling engine.

A non-lubricated β-type (or commonly called displacer type) engine has a power piston and displacer coaxially disposed within the same cylinder. In order to move the displacer, a displacer rod is coaxially mounted through the centre of the power piston. There arises a need to seal the displacer rod from the power piston. This has been accomplished with various sealing arrangements.

Since a non-lubricated β-type engine can from time to time experience wear problems in the power piston sealing assembly there is a need for a power piston sealing assembly that is compact and easily serviceable.

U.S. Pat. No. 4,251,081 relates to an oil lubricated Stirling engine having sealing means for preventing gas leakage along a reciprocating piston rod. The basic principle of this seal is that the sealing gland has a tubular extension having a slightly increased diameter in the direction towards the high pressure chamber. The extension is located outside the part of the gland exposed to radial forces.

U.S. Pat. No. 4,645,212 also relates to an oil lubricated Stirling engine. This specification describes a pumping type seal arrangement for preventing gas leakage along a reciprocating piston rod that separates a high pressure gas chamber from a low pressure gas chamber.

While the above mentioned seal arrangements function satisfactorily in oil lubricated Stirling engines, they are too complicated and expensive to implement in non lubricated Stirling engines. Incorporating the above mentioned seals in a hermetically sealed beta-Stirling engine would pose problems due to the lack of available space in the power piston. In addition there is no need for a pumping seal action within a non lubricated Stirling engine, because the pressure differential between the working cylinder (chamber) and the pressurised crankcase is minimal.

### DISCLOSURE OF THE INVENTION

It is an object of the present invention to provide a Stirling engine with a power piston sealing assembly that is compact, thereby reducing the height of the engine. It is another object of the present invention to provide a Stirling engine with a power piston sealing assembly that is reliable and easily serviceable. It is a further object of the present invention to provide a power piston with a seal arrangement which is easy to manufacture, with simple assembly and dismantling, and which is reliable in use.

The present invention has in a first aspect a power piston for use in a Stirling engine. The power piston has a centre axis and comprises a concentric hole for positioning of a sealing arrangement between the power piston and a displacer rod insertable in the hole. The sealing arrangement comprises at least one sealing set positioned within the concentric hole. A sealing set comprises of at least one displacer rod seal element, at least one displacer rod spring element, and a seal retainer, securing all the seals within the concentric hole. There may preferably be two displacer rod seal elements and a fixing element between the two displacer rod seal elements. The fixing element locates the two elements relative to each other to prevent them from relative rotational movement. The fixing element may be a separate element such as a dowel or may be formed as a part of one or both of the two displacer rod seal elements cooperating with each other to fix the two elements. One can also envisage only one displacer rod seal element or three such elements.

In a preferred embodiment of the invention the sealing arrangement comprises two sets each comprising two displacer rod seals, a fixing element, displacer rod seal spring element and a seal retainer. The two sets are arranged one above the other within the concentric hole. One may of course envisage more sets positioned within the hole.

The seal retainer is connected to the power piston for securing all the seals within the concentric hole of the power piston. This may be done in several ways. A preferred embodiment is to form the concentric hole in at least a part of the hole with internal threads and form the seal retainer of the sealing arrangement with threads in its outer surface for engagement with the internal threads of the concentric hole. Other solutions are to have a snap-in connection with elements or parts of the concentric hole cooperating with elements or parts of the seal retainer; or a solution with an ‘insert and rotate to lock’ solution. The important issue is to fix the seal retainer in relation to the power piston.

In the preferred embodiment the concentric hole in the power piston comprises an internal shoulder for abutment against a part of the sealing arrangement. The shoulder divides the hole in the power piston into at least two sections, a first section for positioning the sealing arrangement, which first section has a first internal diameter larger than the outer diameter of the displacer rod running from a side and into the shoulder, and a second section from the shoulder with a second inner diameter mainly equal to the outer diameter of the displacer rod.

According to the invention the seal retainer is a disk like element with two side surfaces oriented mainly normal to a centre axis and an outer circumferential surface. The seal retainer further comprises a through going hole with an inner diameter mainly equal to an outer diameter of the displacer rod that should be inserted in the hole. The inner hole has an inner concentric recess, which is formed from the inner diameter of the hole to a second diameter less than an outer diameter of the disk like element, the circumferential surface diameter, and with a height in the direction of the centre axis. The height of the recess is from one side surface of the seal retainer and in a direction of the centre axis.

According to the invention a preferred embodiment of the displacer rod spring is a split ring for positioning within the inner concentric recess of the seal retainer. Also the displacer rod seal element(s) is/are split seal elements with a gap for positioning around displacer rod within the inner concentric recess of the seal retainer. Alternatively the seals may be solid.

Preferably the height of the inner concentric recess is less than the height or combined height of the displacer rod seal element(s), depending on the number of seal elements, in a direction of the centre axis.

In the embodiment with more than one seal element, the seal elements comprise corresponding grooves for positioning of the fixing element preferably in the form of a dowel for fixing the elements relative to each other. There may be envisaged other fixing elements, as separate elements or parts of the seal elements that fix the seal element relative to each other.

The invention also provides a seal retainer for use in a sealing arrangement in a power piston as discussed above and a Stirling engine wherein it comprises a power piston according to the above disclosure.

In accordance with the present invention, there is provided a power piston sealing assembly that gives a compact design and is easily serviceable.

### BRIEF DESCRIPTION OF THE DRAWINGS

A specific embodiment of the invention will now be described by way of example with reference to the accompanying drawings, in which:—

FIG. 1 shows schematically a simplified Stirling engine (for the purpose of explanation),

FIG. 2 is a perspective view of the power piston according to the invention,

FIG. 3 is a cross section of the power piston shown in FIG. 2,

FIG. 4 is a cross section of the power piston shown in FIGS. 2 and 3 with a sealing assembly,

FIG. 5 is a perspective exploded view of the seal retainer assembly—seen from underneath,

FIG. 6 is two views of the first displacer rod seal,

FIG. 7 is two views of the second displacer rod seal,

FIG. 8 is a perspective exploded view of the power piston with the sealing assembly, and

FIG. 9 is a cross section of the displacer, displacer rod and piston sealing assembly.

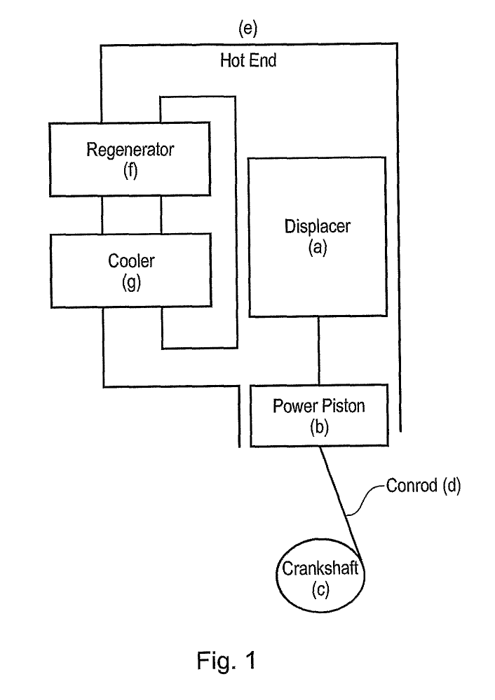

### DESCRIPTION OF THE SPECIFIC EMBODIMENT

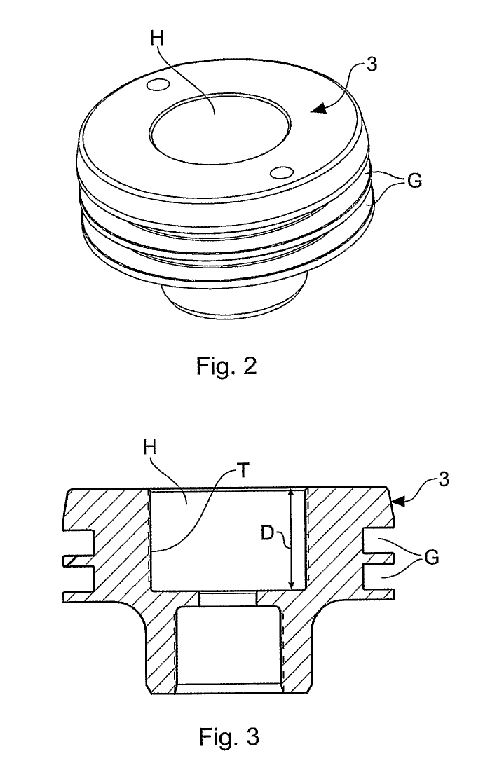

FIG. 2 shows a perspective view of a power piston 3 according to the invention. The power piston has grooves G in its outer circumferential surface wherein piston rings and springs can be mounted. A concentric hole H, extending through the power piston is also shown. This hole H is for inserting and positioning of a displacer rod and a sealing arrangement between the power piston and the displacer rod.

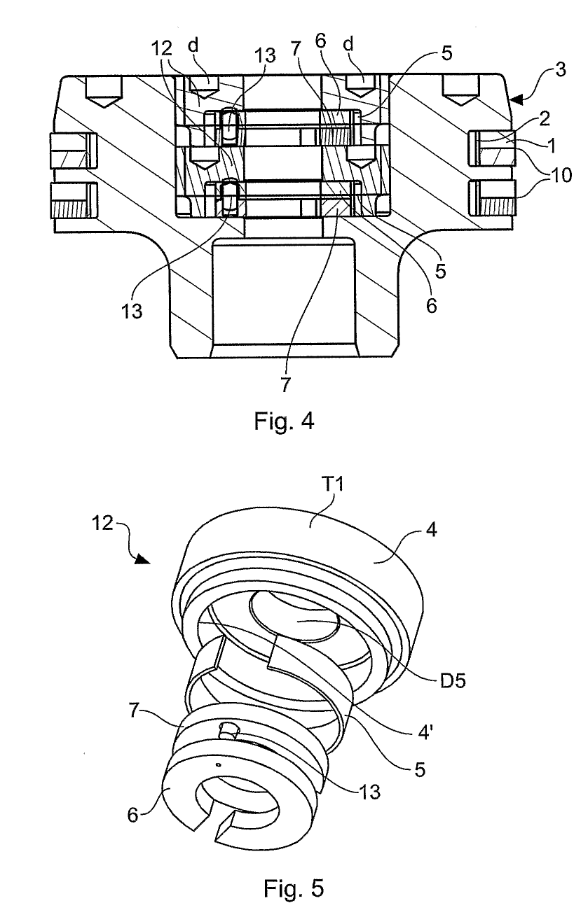

FIG. 3 is a cross section of the power piston 3 in FIG. 2. The power piston 3 has the circumferential grooves G in its outer surface whereby piston rings with springs can be installed. The concentric hole H is provided in the power piston 3, and as can be seen from the figure, comprises first, second and third sections along the centre axis. The first section extends from an upper surface of the piston along the centre axis for a height D, ending in a shoulder formed within the hole H. The first section has a diameter larger than an outer diameter of a displacer rod that should be inserted within the hole H. The second section is formed by the shoulder part of the hole H and has an inner diameter very slightly larger than the outer diameter of the displacer rod. Below the shoulder in the figure there is a third section of the hole H, with a third diameter. The first section has internal threads T, and is threaded to the necessary depth D, (shown as down to the shoulder and second section of the hole H), in order to install the seal retainer to be described in relation to FIG. 4.

FIG. 4 is a cross section of the power piston assembly with sealing arrangements. The outer piston ring assembly 10 has piston rings 1 and springs 2 positioned and located within the grooves G. The sealing arrangements for sealing between the power piston and the displacer rod, called the seal retainer assemblies 12, are threaded in the power piston hole H.

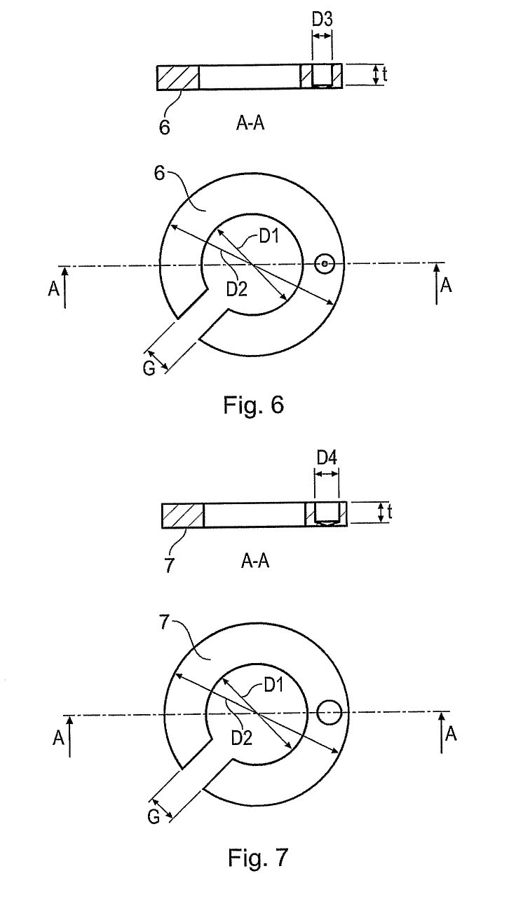

FIG. 5 is a perspective exploded view of one seal retainer assembly 12. The seal retainer 4, which is a disk like element formed with two surfaces mainly normal to a centre axis and an outer circumferential surface, also comprises a through going hole with a diameter D5, mainly equal to an outer diameter of the displacer rod. The seal retainer 4 further has an inner recess 4′ that is turned or machined so that two displacer rod seals 6, 7 and displacer rod seal spring 5 can be fitted mainly within that recess 4′. The displacer rod seal spring 5 could be a spring, ‘O’ ring, or other energising ring. A dowel 13 with an outer diameter is fitted into grooves in both displacer rod seals 6 and 7. Said dowel 13 locks the first and second displacer rod seals 6,7 in place and hinders them from rotating relative to each other. The outer circumferential surface of the seal retainer 4 is fitted with male threads T1 that correspond to the female threads T in power piston 3.

FIG. 6 is a view of the first displacer rod seal 6. As shown this seal 6 has an inner diameter D1, outer diameter D2 and thickness t. In addition a bore with diameter D3 is drilled into displacer rod seal 6. This diameter is equal to the outer diameter of the dowel 13. The displacer rod seal 6 is split with a gap G. This is to compensate for thermal expansion of the displacer seal and avoid the possibility of the seal opening or distorting when reaching its operating temperature. If this happens the seal may leak and the Stirling engine's performance will drop. Another possibility is to utilize a solid rod seal 6 without the gap. This will impose greater tolerances upon the seal, and a thermally stable material must be used

FIG. 7 is a view of the second displacer rod seal 7. As shown this seal has an inner diameter D1, outer diameter D2 and thickness t. In addition a bore with diameter D4 is drilled into displacer rod seal 7. This diameter is slightly larger than the diameter of dowel 13. The displacer rod seal is also split with a gap G. This is to compensate for thermal expansion of the displacer seal and avoid the possibility of the seal opening or distorting when reaching its operating temperature. If this happens the seal may leak and the Stirling engine's performance will drop. Another possibility is to utilize a solid rod seal 6 without the gap. This will impose greater tolerances upon the seal, and a thermally stable material must be used. The diameter D4 may also be equal to the diameter D3 of the first displacer rod seal 6, as shown in FIG. 6.

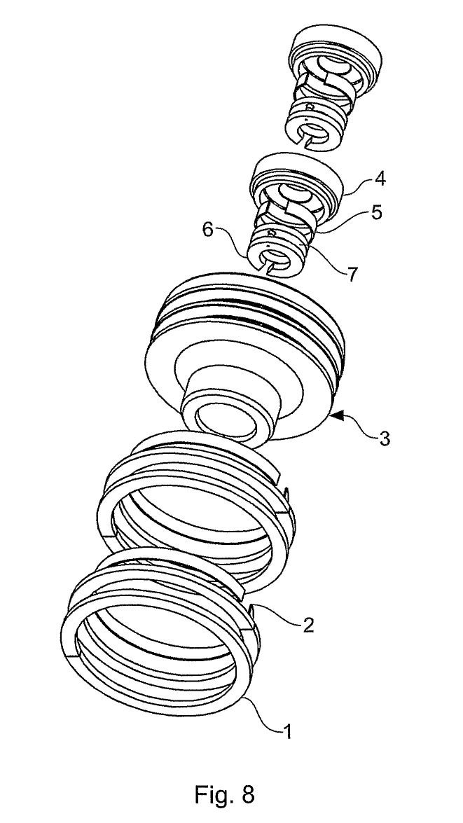

FIG. 8 is a perspective exploded view of the power piston assembly. The power piston 3 is shown with its corresponding piston rings 1 and springs 2. The seal retainer 4 is shown with its corresponding displacer rod seals 6, 7 and the displacer rod seal spring 5. There are two seal retainers 4 for positioning within the hole of the power piston.

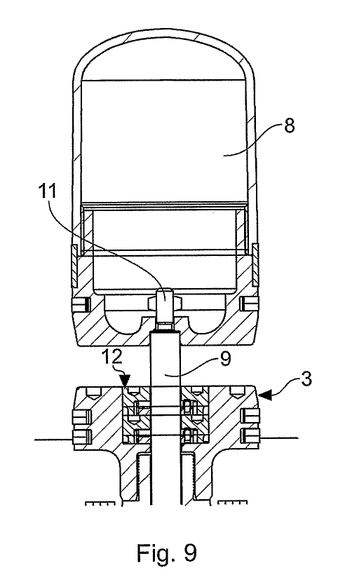

FIG. 9 is a cross section of the displacer, displacer rod and piston sealing assembly. The power piston 3 with its sealing assembly 12 is concentrically placed with respect to the displacer 8. The displacer 8 is connected to the displacer rod 9 by means of a nut 11. The displacer rod 9 runs concentrically through the power piston 3 and the displacer rod seals 6, 7 (see FIG. 4). The displacer rod seals 6, 7 grip around the displacer rod 9 and provide a sealing surface engagement. A positive seal around the displacer rod is performed by the compressive action of displacer seal spring 5. The gap between the displacer rod seals 6, 7 permits the seals to compensate for abrasive wear.

Turning back to FIG. 5, the height of recess 4′ of the seal retainer is adjusted to the sealing requirement of the displacer rod seals 6, 7. The height of recess 4′ is usually less than the height (or thickness) of displacer rod seals 6, 7. This ensures a tight fit between displacer rod seals 6, 7 against seal retainer 4 and avoids any vertical movement of the seals 6, 7 during oscillation of power piston 3.

Assembly of the power piston sealing assembly is quite straightforward. For installation purposes reference is made to FIG. 4 which shows the cross section of the power piston sealing assembly and FIG. 8 which is an exploded view of the power piston sealing assembly. To begin with the displacer seals 6, 7 are assembled together and positioned together with dowel pin 13. Then displacer rod spring 5 is fitted around the displacer seals 6, 7. Next, the displacer seals 6 and 7 with spring 5 are placed concentrically into the seal retainer recess 4′. Then the seal retainer 4 with sealing assembly is fastened to the power piston 3 by means of the threads T in the outer surface and the hole H. In order to screw the seal retainer 4 into the power piston 3 a special tool with two claws may be used (not shown). These claws can each have a diameter of e.g. 4 mm that fit into the seal retainers' pre-drilled holes d. If the application requires a second sealing assembly the installation process is repeated in the same order. Finally, the piston ring spring assembly is installed. The springs 2 are first installed in the piston groove G and thereafter the piston rings 1 are installed.

Now, the power piston sealing assembly is ready to be fixed to the power crosshead. The displacer rod 9 is pushed through the centre of the assembly and is fixed to the displacer 8 with e.g. a nut 11.

If or when there is a need to overhaul or change the power piston sealing assembly, the assembly sequence is simply reversed.

The invention has now been explained with an embodiment, a skilled person will however understand that one may make alterations and modifications to this embodiment and will be within the scope of the invention. There may for instance be only one seal retainer arranged within the hole in the power piston, there may be three displacer rod seal elements within a seal retainer, the connection between the seal retainer and power piston may be achieved in other ways than with threads etc.

1-15. (canceled)

16. A power piston in a Stirling engine, which piston has a centre axis and comprises a concentric hole for positioning of a sealing arrangement between the power piston and a displacer rod insertable in the hole, wherein the sealing arrangement comprises at least one set of at least one displacer rod seals, at least one resilient means to bias the displacer rod seal(s), and a seal retainer, securing all the seats within the concentric hole.

17. A power piston as claimed in claim 16, in which there are two displacer rod seals.

18. A power piston as claimed in claim 16, in which the resilient means to bias the displacer rod seal(s) is a displacer rod spring.

19. A power piston as claimed in claim 16, in which the sealing arrangement comprises two sets of two displacer rod seals, a fixing element, a displacer rod seal spring and a seal retainer, arranged one above the other within the concentric hole.

20. A power piston as claimed in claim 19, in which the fixing element is a dowel.

21. A power piston as claimed in claim 16, in which at least a part of the concentric hole has internal threads.

22. A power piston as claimed in claim 21, in which the seal retainer of the sealing arrangement comprises threads in its outer surface for engagement with the internal threads of the concentric hole.

23. A power piston as claimed in claim 16, in which the concentric hole comprises an internal shoulder for abutment against a part of the sealing arrangement.

24. A power piston as claimed in claim 16, in which the seal retainer is a disk like element with a through going hole with an inner diameter, with an inner concentric recess from the inner diameter to a second diameter less than an outer diameter of the disk like element and with a height in the direction of the centre axis, in one side surface of the seal retainer.

25. A power piston as claimed in claim 24, in which the displacer rod spring is a split ring for positioning within the inner concentric recess of the seal retainer.

26. A power piston as claimed in claim 24, in which the height of the inner concentric recess is less than the height of the displacer rod seals in a direction of the centre axis.

27. A power piston as claimed in claim 24, in which the height of the inner concentric recess is less than the height of the displacer rod seals in a direction of the centre axis, and in which the displacer rod seals are split seals with a gap for positioning around the displacer rod.

28. A power piston as claimed in claim 24, in which the height of the inner concentric recess is less than the height of the displacer rod seals in a direction of the axis, and in which the displacer seals are solid.

29. A seal retainer for use in a sealing arrangement in a power piston, wherein the seal retainer is a disk like element with a centre axis, two surfaces mainly normal to the centre axis and a circumferential surface, where the seal retainer comprises a through going hole in at least two sections, the uppermost section having being formed as an inner recess, and threads in the outer circumferential surface.

30. A Stirling engine including a power piston according to claim 16.

31. A Stirling engine including a seal according to claim 29.
